(19) United States
(12) Patent Application Publication
(10) Pub. No.: US 2013/0247542 A1
(43) Pub. Date: Sep. 26, 2013

(54) SPACE LAUNCHER PROPULSION SYSTEM IMPLEMENTING A METHOD OF REGULATING PROPELLANT COMPONENT CONSUMPTION

(71) Applicant: Serge Le Gonidec, Vernon (FR)

(72) Inventor: Serge Le Gonidec, Vernon (FR)

(73) Assignee: SNECMA, Paris (FR)

(21) Appl. No.: 13/823,327

(22) PCT Filed: Sep. 20, 2011
(86) PCT No.: PCT/FR11/52157

§ 371 Date: Jun. 10, 2013

(30) Foreign Application Priority Data
Sep. 28, 2010 (FR) 1057778

(51) Int. Cl. F02K 9/00

(52) U.S. Cl. CPC F02K 9/00
USPC 60/204; 60/200.1

(57) ABSTRACT

A space launcher propulsion system includes: an engine fed by at least two propellant component tanks; a measurement mechanism to measure a quantity of propellant component actually consumed in each of the tanks, by sensors becoming uncovered; an estimation mechanism to estimate instantaneous flow rates of each of the propellant components on the basis of at least one operating parameter of the engine; and a correction mechanism correcting the way the estimation mechanism estimates on the basis of the measured consumed quantities and of the estimated instantaneous flow rates.

### BACKGROUND OF THE INVENTION

The invention lies in the field of engines using a plurality of propellant components, and more particularly to the field of space launcher propulsion systems having at least two propellant component tanks.

More precisely, the invention seeks to optimize the consumption of propellant components in such launchers.

In general, in the present state of the art, space launcher engines are pre-set, which means that they have a predetermined operating point throughout the duration of the flight, with this setting not being adjusted during the flight.

This presents a first drawback since with a setting that is predetermined it is not possible to adapt effectively to changes in the behavior of the engine during the flight, e.g. in the event of a failure or of a subsystem becoming less efficient.

Furthermore, in order to mitigate the uncertainties of such a setting, it is usual to overfill the tanks with propellant components in order to cover need for thrust regardless of the uncertainties concerning the mixing ratio.

In practice, it turns out that at least one of the tanks is not empty at the end of propulsion.

It can be understood that this is not desirable, since the non-consumed component mass constitutes a wasted load for the launcher.

Document FR 2 524 938 describes a method of regulating the propellant component mixing ratio in an engine having propellant components, which method consists in measuring the flow rates of the propellant components at the outlets of turbopumps, in comparing those flow rates with setpoint values, and in acting on the speeds of the turbopumps so as to ensure that the propellant components are totally exhausted when the operation of the engine stops.

That method presents a major drawback in that it requires the use of flow meters, where such instrumentation is not usable in practice for reasons of cost and weight, and depending on the technology, for reasons of accuracy.

### OBJECT AD SUMMARY OF THE INVENTION

The present invention proposes a method of regulating the consumption of propellant components stored in the tanks of a space launcher, which method does not have the drawback of methods known in the prior art.

More precisely, in a first aspect, the invention provides a method of regulating the consumption of propellant components stored in at least two tanks of a space launcher, the method comprising:
a measuring step of measuring the quantity of propellant component actually consumed in each of said tanks, by sensors becoming uncovered;
an estimation step of estimating instantaneous flow rates of each of the propellant components on the basis of at least one operating parameter of the engine; and
a correction step of correcting the way the estimation step is performed on the basis of the measured consumed quantities and on the basis of the estimated instantaneous flow rates.

Correspondingly, the invention also provides a space launcher engine fed from at least two propellant component tanks, the engine comprising:
measurement means suitable for measuring the quantity of propellant component actually consumed in each of the tanks, by sensors becoming uncovered;
estimation means suitable for estimating the instantaneous flow rates of each of the propellant components on the basis of at least one operating parameter of the engine; and
correction means for correcting the way the estimation means estimate on the basis of said measured consumed quantities and of the estimated instantaneous flow rates.

Thus, the regulation method and the method of the invention are remarkable in that they do not make use of flow meters for measuring the flow rates of the propellant components.

On the contrary, in accordance with the invention, the flow rates of the propellant components are estimated, with the estimation function being readjusted during flight, after each measurement of the quantity of propellant component that has actually been consumed in each of the tanks, with the instants that they measurements are taken being referred to as “rendezvous points”.

The invention also makes it possible to correct the estimation functions, given that they might drift during flight, e.g. in the event of a degradation in the performance of a subsystem of the engine.

In a particular implementation of the invention, the measured consumed quantities and the estimated instantaneous flow rates for each of the propellant components are also used to correct at least one of the engine regulation setpoints in such a manner as to obtain total exhaustion of both propellants when the operation of the engine stops.

Preferably, the quantities of propellant component measured by sensors becoming uncovered are taken by using probes that are discrete or semi-discrete and that are arranged at different levels in the tanks, each of the probes being suitable for issuing a signal when it is no longer immersed in the propellant component.

As non-limiting examples, temperature probes or capacitive probes may be used for this purpose.

In a particular implementation of the invention, the engine parameters used for estimating the instantaneous flow rates of propellant components are the speeds of rotation of turbopumps associated with the tanks, and the thrust of the engine, with thrust being deduced directly from the pressure in the combustion chamber of the engine.

In a particular implementation, the various steps of the regulation method are determined by computer program instructions.

Consequently, the invention also provides a computer program on a data medium, the program being suitable for being performed by a computer, the program including instructions adapted to performing steps of the regulation method as mentioned above.

The program may use any programming language, and be in the form of source code, object code, or code intermediate between source code and object code, such as in a partially compiled form, or in any other desirable form.

The invention also provides a computer-readable storage medium including instructions of a computer program as mentioned above.

The data medium may be any entity or device capable of storing the program. For example, the medium may comprise storage means, such as a read-only memory (ROM), e.g. a compact disk (CD) ROM, or a microelectronic circuit ROM, or indeed magnetic recording means, e.g. a floppy disk or a hard disk.

Alternatively, the data medium may be an integrated circuit in which the program is incorporated, the circuit being adapted to execute or to be used in the execution of the method in question.

### BRIEF DESCRIPTION OF THE DRAWINGS

Other characteristics and advantages of the present invention appear from the following description of the accompanying drawings that show an embodiment having no limiting character. In the figures:

FIG. 1 shows a space launcher engine in accordance with a first embodiment of the invention;

FIG. 2 is a flow chart showing the main steps of a regulation method in accordance with the invention;

FIG. 3 shows how a regulation setpoint for the FIG. 1 engine varies;

FIGS. 4A and 4B show how the residual masses of the propellant components vary in each of the tanks of the FIG. 1 engine;

FIG. 5 shows variation in the remaining time to exhaustion of the volumes of propellant components for the FIG. 1 engine, as estimated or calculated; and

FIG. 6 shows a space launcher engine in accordance with a second embodiment of the invention.

### DETAILED DESCRIPTION OF THE INVENTION

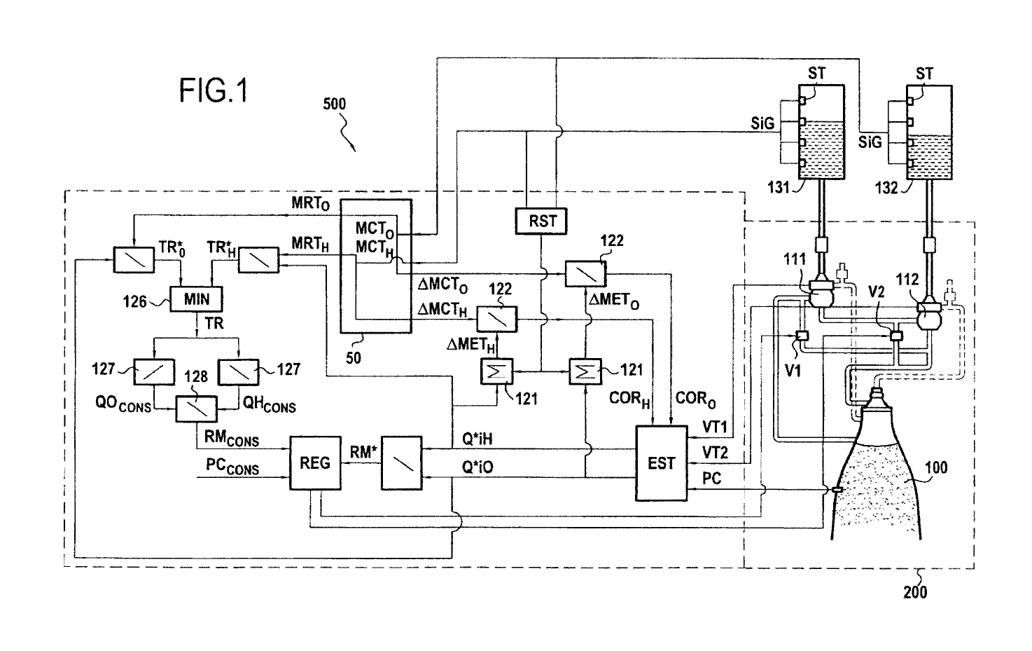

FIG. 1 shows a propulsion system in accordance with the invention. The propulsion system comprises a calculation device 500, an engine 200, and two propellant component tanks referenced 131 and 132, respectively containing hydrogen and oxygen, in this example.

The propellant component tanks 131 and 132 are placed upstream from respective pumps 111 and 112, with the flow rate of each of these propellant components being capable of being regulated by valves V1 and V2 of the engine 200.

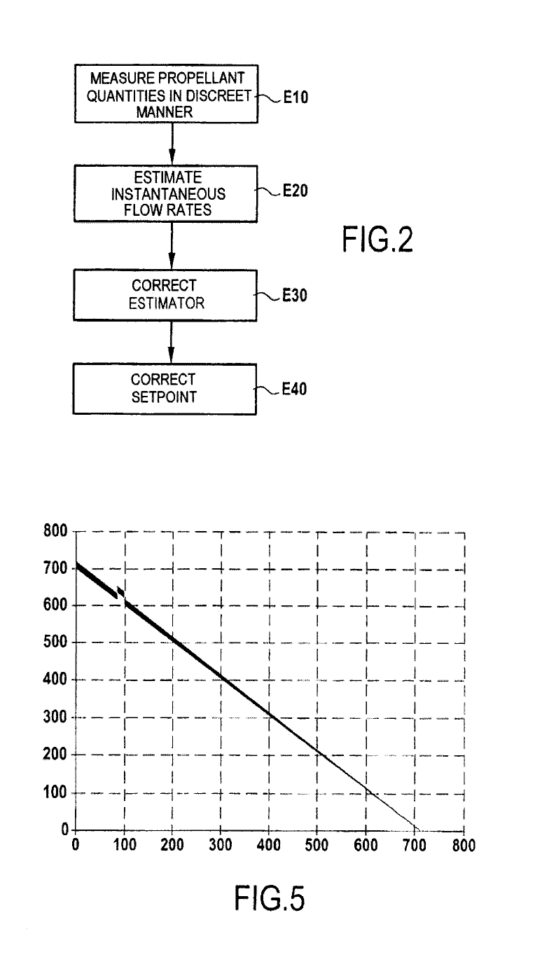

In the embodiment described herein, the calculation device 500 is constituted by a controller suitable for implementing the method that is shown in the form of a flow chart in FIG. 2.

In the presently described embodiment, the calculation device 500 has regulation means REG that receive as input two regulation setpoints for the engine, namely a setpoint PC_{cons} for the pressure in the combustion chamber 100 of the engine, and a setpoint RM_{cons} for the ratio of the mass flow rates of the propellant components at the inlet to the combustion chamber 100.

In accordance with the invention, the propulsion system has means for measuring, in discrete manner, the quantities of propellant components that are actually consumed in each of the tanks 131 and 132.

More precisely, in the presently described embodiment, temperature probes ST are arranged at different levels in the tanks 131, 132, with these probes ST being adapted to generate a signal SIG as soon as they are no longer immersed in the propellant components.

By way of example, in a variant it would be possible to use capacitive probes.

Naturally, the tanks do not empty at the same speed, so the signals SIG are issued independently at instants that are referred to as “rendezvous points”.

During a step E10 of the regulation method in accordance with the invention, and at each rendezvous point, a signal SIG is received by means 50 suitable for determining the total mass of propellant component that has been consumed in the tank in question.

The total consumed masses of oxygen and hydrogen are written MCT_{O} and MCT_{H}.

Furthermore, and in accordance with the invention, the calculation device 500 includes means EST for acting during a step E20 of the regulation method of the invention to estimate the instantaneous flow rates Q_{i*o} and Q_{i*H} of each of the propellant components, on the basis of one or more operating parameters of the engine.

In the presently described implementation, these operating parameters are the speeds VT1 and VT2 of the turbopumps 111 and 112, and the pressure PC in the combustion chamber 100.

These estimation means EST use an estimation function that is suitable for being corrected at each of the rendezvous points.

More precisely, the calculation device 500 includes integration means 121 suitable for acting between two rendezvous points to sum the instantaneous estimated flow rates Q_{i*H} and Q_{i*o}.

The total estimated masses of hydrogen and oxygen as consumed between two rendezvous points are written respectively ΔMET_{H} and ΔMETₒ.

In this embodiment, the calculation device 500 includes means RST for resetting the integration means 121 at each rendezvous point, in other words on each occurrence of the signal SIG.

In this embodiment, the calculation device 500 includes means 122 for comparing the estimated totals ΔMET_{H} and ΔMET_{O} with the real variations in consumed mass ΔMCT_{O} and ΔMCT_{H}, the results COR_{H} and COR_{O} of these comparisons being delivered as inputs to the estimation means EST in order to adjust the flow rate estimation function.

The estimated mixing ration RM* of the propellant components is supplied as input to the engine regulation means REG.

The adjustment or correction of the estimation function as implemented in the estimation step is thus performed during a general step E30 of the regulation method as shown in FIG. 2.

In the embodiment described herein, the regulation means REG of the engine receive two setpoints as input, namely a pressure setpoint PC_{cons} for the pressure in the combustion chamber 100, and a mixing ratio setpoint RM_{cons}

In the implementation described herein, the setpoint RM_{cons} for the mixing ratio is corrected at each rendezvous point so as to ensure that both of the propellant components are totally exhausted when the engine 200 stops operating.

For this purpose, and on the basis of the total remaining masses (MRT_{O}, MRT_{H}) and of the estimated instantaneous flows rates (Q_{i*o}, Q_{i*H}) , the instants (TR*_{H}, TR*ₒ) are determined at which each of the two tanks 131, 132 will be completely empty assuming that the operation of the engine does not change, by dividing each total remaining mass (MRT_{H}, MRTₒ) by the corresponding estimated instantaneous flow rate (Q_{i*o}, Q_{i*H}).

The value TR of the smaller of these two values Q_{i*o} and Q_{i*H} is then retained and referred to below as the “residual time”.

After estimating the minimum duration TR, the means 127 recalculate the setpoint flow rates (QO_{cons}, QH_{cons}) suitable for ensuring that both propellant components are completely exhausted at the same time.

By dividing these flow rates (function 128), the mixing ratio setpoint RM_{cons} is obtained.

Correcting this setpoint RM_{cons} constitutes a step E40 of the regulation method of the invention.

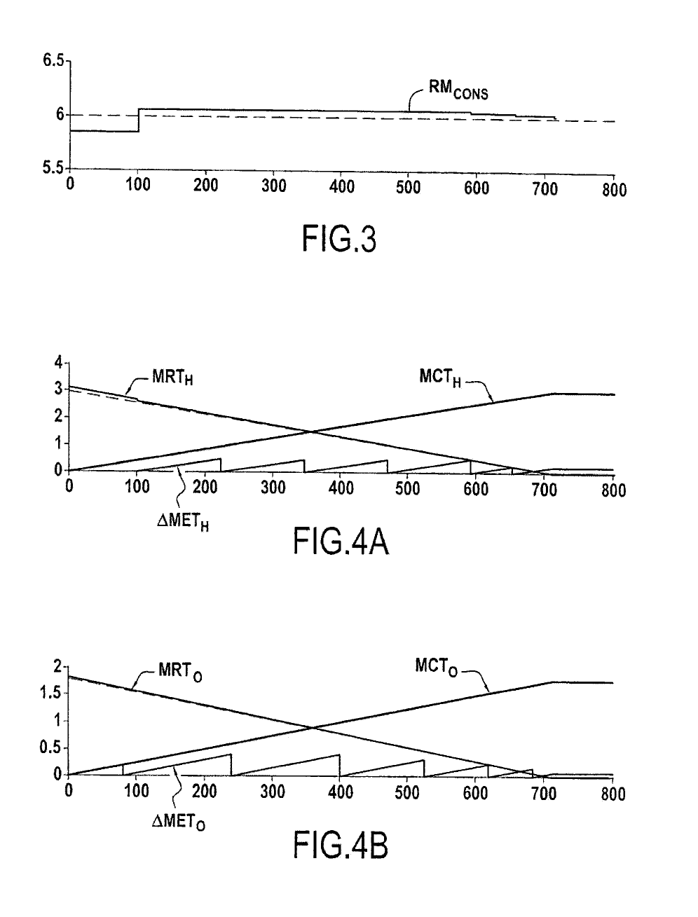

FIG. 3 serves to illustrate how the above-mentioned setpoint RM_{cons} varies.

The dashed line shows the ratio at which the masses of oxygen and hydrogen are mixed when the launcher is started (ratio=6).

It is of interest to observe in this figure that the setpoint RM_{cons} on starting is different from the ratio of the propellant components, with the regulation method of the invention serving quite quickly to re-adjust this setpoint so as to ensure that both propellant components will be totally exhausted simultaneously at the time the engine stops operating.

With reference to FIGS. 4A and 4B, it can be seen how the residual masses MRT_{H} and MRT_{O} of hydrogen and oxygen respectively vary in the tanks 131, 132 (the real residual masses being drawn as continuous lines and the estimated masses as dashed lines, with these curves coinciding for oxygen).

The total and estimated consumed masses MCT_{H}, MCT_{O} and ΔMET_{H}, ΔMET_{O} between two rendezvous points are also shown.

FIG. 5 plots real time along the abscissa axis and residual time TR as obtained at the output from the comparator 126 up the ordinate axis.

Between 80 seconds (s) and 100 s, it can be seen that the minimum residual time TR varies following a correction to one of the estimated residual masses MRT₀ and/or MRT_{H}.

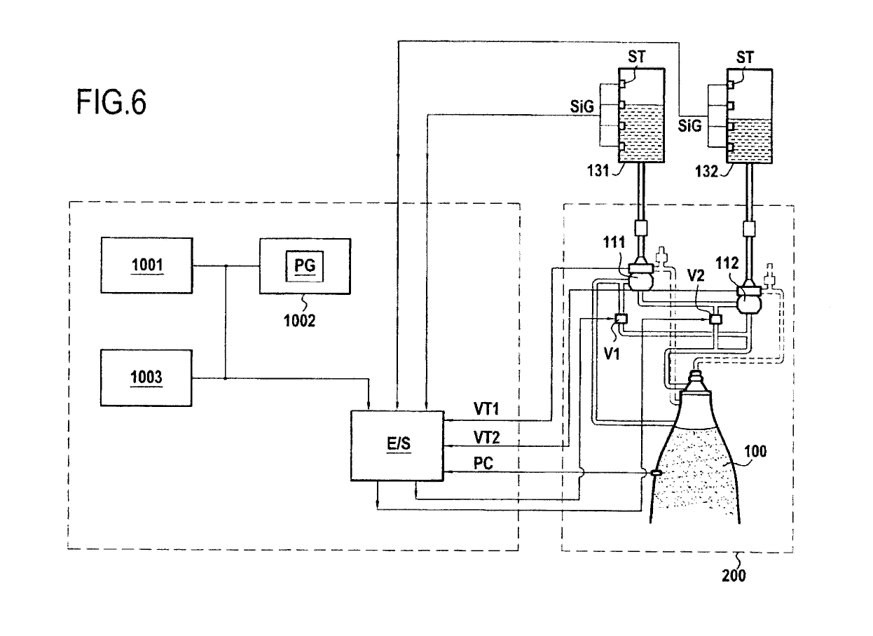

FIG. 6 shows a space launcher engine in accordance with a second embodiment of the invention.

In this embodiment, the method of regulating propellant component consumption is performed by a computer program PG stored in a storage medium 1002, the program being suitable for being executed by a processor 1001, with the variables needed for executing this program being stored temporarily in a random access memory (RAM) 1003.

The computer program receives as inputs via an input/output module (E/S) the signals SIG issued by the tanks 131 and 132 at each of the rendezvous points. The computer program is suitable for calculating the total consumed masses MCT_{O} and MCT_{H} of oxygen and hydrogen and for estimating the estimated flow rates Q_{i*o}and Q_{i*H} of each of these propellant components on the basis of operating parameters of the engine, which parameters are constituted in this example by the speeds VT1 and VT2 of the turbopump and by the pressure PC in the combustion chamber.

The computer program is suitable for performing the operations described above with reference to the embodiment of FIG. 1.

In particular, it includes instructions for comparing the estimated total consumed masses of hydrogen and oxygen (ΔMET_{H} and ΔMET_{O}) with the real variations in consumed masses (ΔMCT_{O} and ΔMCT_{H}) in order to adjust the flow rate estimation function.

The computer program thus serves, at each rendezvous point, to correct the mixing ratio setpoint RM_{cons} so that total exhaustion of the two propellant components can be obtained when the operation of the engine 200 stops.

This mixing ratio setpoint RM_{cons} and a pressure setpoint PC_{cons} serve to regulate the flow rates through the valves V1 and V2.

1-8. (canceled)

9. A method of regulating consumption of propellant components stored in at least two tanks of a space launcher engine, the method comprising:
measuring a quantity of propellant component actually consumed in each of the tanks, by sensors becoming uncovered;
estimating instantaneous flow rates of each of the propellant components on the basis of at least one operating parameter of the engine; and
correcting the way the estimating is performed on the basis of the measured consumed quantities and on the basis of the estimated instantaneous flow rates.

10. A regulation method according to claim 9, wherein the engine is regulated to tend towards at least one setpoint, and the method further comprises:
correcting the at least one setpoint on the basis of the measured consumed quantities and the estimated instantaneous flow rates so as to obtain total exhaustion of both propellant components when operation of the engine stops.

11. A space launcher propulsion system comprising:
an engine fed from at least two propellant component tanks;
measurement means configured to measure a quantity of propellant component actually consumed in each of the tanks, by sensors becoming uncovered;
estimation means for estimating instantaneous flow rates of each of the propellant components on the basis of at least one operating parameter of the engine; and
correction means for correcting the way the estimation means estimates on the basis of the measured consumed quantities and the estimated instantaneous flow rates.

12. A propulsion system according to claim 11, wherein the engine is regulated to tend towards at least one setpoint, and the system further comprises:
correction means for correcting the at least one setpoint on the basis of the measured consumed quantities and of the estimated instantaneous flow rate so as to obtain total exhaustion of both propellant components when operation of the engine stops.

13. A propulsion system according to claim 11, wherein the estimation means uses as operating parameters speeds of rotation of turbopumps associated with each of the tanks, and a pressure in a combustion chamber of the engine.

14. A propulsion system according to claim 11, wherein the measurement means uses discrete or semi-discrete probes that are arranged at different levels in the tanks and that are configured to issue a signal when they are no longer immersed in the propellant components.

15. A non-transitory computer-readable storage medium storing computer executable instructions for executing a method of regulating propellant component consumption according to claim 9.
